(19) United States
(12) Patent Application Publication
(10) Pub. No.: US 2024/0233006 A1
(43) Pub. Date: Jul. 11, 2024

(54) DELIVERY OF CUSTOMIZED RESOURCE

(71) Applicant: Truist Bank, Charlotte, NC (US)

(72) Inventor: Barath Jayaraman, Fort Mill, SC (US)

(73) Assignee: Truist Bank, Charlotte, NC (US)

(21) Appl. No.: 18/151,664

(22) Filed: Jan. 9, 2023

(51) Int. Cl. G06Q 40/02; G06Q 20/10

(52) U.S. Cl. CPC G06Q 40/02; G06Q 20/108

(57) ABSTRACT

A system for delivering a customized resource through a point of interaction associated with a first entity with which a user holds a first account and a second account. The system authenticates the user and grants remote user access over the Internet to a user device. After receiving a request to deliver a customized resource from the first entity to a second entity, the system combines at least a portion of the balance of the first account and at least a portion of the balance of the second account into a customized resource and delivers that to the second entity. The system also allows a user to add an external account associated with a second entity for any interaction a user may have with the first entity such as bill-pay, transfers, etc. The external account may also be used for delivering the customized resource.

### FIELD

This invention is related generally to the field of banking and more particularly embodiments of the invention relate to automatically saving primary and secondary payment sources across various payment products, using multiple accounts for a single payment, and using secondary or external accounts for payments.

### BACKGROUND OF THE INVENTION

A bank is a financial institution that is licensed to receive deposits from individuals and organizations and to make loans to those individuals and organizations or others. Banks may also perform other services such as wealth management, currency exchange, etc. Therefore, a bank may have thousands of customers and clients. Depending on the services that a bank provides, it may be classified as a retail bank, a commercial bank, an investment bank or some combination thereof. A retail bank typically provides services such as checking and savings accounts, loan and mortgage services, financing for automobiles, and short-term loans such as overdraft protection. A commercial bank typically provides credit services, cash management, commercial real estate services, employer services, trade finance, etc. An investment bank typically provides corporate clients with complex services and financial transactions such as underwriting and assisting with merger and acquisition activity.

Often times, a customer, or user, will have their finances and assets maintained by more than one financial institute. Generally, interactions between the customer's accounts at the various financial institutes are time consuming and may become costly if one or both of the banks assess a fee for the transaction or interaction. A user may also be unaware of the total balance at each institute, and may therefore incur more expenses if the customer overdraws from a particular account.

Accordingly, needs exist for a straightforward and simplified system for allowing users to access their assets across multiple accounts and between various financial institutes without the need for additional transfers and transactions or a waiting period.

### BRIEF SUMMARY

Embodiments of the present invention address the above needs and/or achieve other advantages by providing systems and methods that make bill-pay and other banking transactions such as transfers easier for a banking customer.

According to embodiments of the invention, a system for delivery of a customized resource includes at least one processor, a communication interface communicatively coupled to the at least one processor and configured to communicate over at least one network with one or more additional sets of processors, and a memory device that stores executable code that, when executed, causes the processor to perform a set of steps including: (1) receive, from a user device, a request for web-based browser or dedicated application interaction associated with a first entity with which a user holds two or more accounts; (2) receive login credentials and a request for remote user access to at least one of the two or more accounts from a user device over the Internet; (3) authenticate the login credentials; (4) in response to successful authentication of the login credentials, generate and transmit a user authentication confirmation over the Internet to the user device; (5) grant remote user access over the Internet to the user device; (6) receive a request to deliver a customized resource from the first entity to a second entity through a point of interaction, wherein the two or more accounts associated with the first entity comprise a first resource associated with at least a first account and a second resource associated with at least a second account; (7) transform at least a portion of the first resource and at least a portion of the second resource into a customized resource; and (8) in response to transforming at least a portion of the first resource and at least a portion of the second resource into a customized resource, deliver the customized resource to the second entity.

According to example embodiments of the invention, a method for delivery of a customized resource includes receiving, from a user device, a request for web-based browser or dedicated application interaction associated with a first entity with which a user holds two or more accounts; receiving login credentials and a request for remote user access to at least one of the two or more accounts from a user device over the Internet; authenticating the login credentials; in response to successfully authenticating the login credentials, generating and transmitting a user authentication confirmation over the Internet to the user device; granting remote user access over the Internet to the user device; receiving a request to complete an interaction between the first entity and a second entity, wherein the two or more accounts associated with the first entity comprise a first resource associated with at least a first account and a second resource associated with at least a second account; transforming the first resource and the second resource into a customized resource, wherein the customized resource comprises at least a portion of the first resource and at least a portion of the second resource; and in response to transforming the first resource and the second resource into a customized resource, completing the interaction between the first entity and the second entity.

Further embodiments of the disclosure include a system for delivery of a customized resource that includes a first processor associated with a first entity and a second processor associated with a second entity, wherein a user holds at least one account associated with the first entity, wherein the user holds at least one additional account associated with the second entity, and wherein the at least one account comprises a first set of resources and the at least one additional account comprises a second set of resources. The system further includes a communication interface communicatively coupled to the first processor and configured to communicate over at least one network with at least the second processor; and a memory device storing executable code that, when executed, causes the first processor to perform a series of steps including: (1) receive, from a user device, a request for web-based browser or dedicated application interaction associated with the first entity; (2) receive login credentials and a request for remote user access to the at least one account from the user device over the Internet; (3) authenticate the login credentials; (4) in response to successful authentication of the login credentials, generate and transmit a user authentication confirmation over the Internet to the user device; (5) grant remote user access over the Internet to the user device; (6) receive a request from the user device to grant the first processor access to the second processor; (7) receive additional login credentials and a request for secondary remote user access to the at least one additional account from the user device over the Internet; (8) receive additional authentication confirmation from the second processor; (9) receive secondary remote user access to the at least one additional account over the Internet to the user device; (10) store the additional login credentials and additional authentication confirmation for subsequent verification; (11) receive a request to complete an interaction between the at least one additional account and the first entity at a point of interaction; (12) transmit the stored additional login credentials to the second processor; (13) receive a grant of secondary remote user access over the Internet to the user device based on the stored additional login; and (14) complete the interaction between the at least one additional account and the first entity.

Example embodiments of the disclosure include a system for delivery of a customized resource, the system comprising at least one processor, a communication interface communicatively coupled to the at least one processor and configured to communicate over at least one network with one or more additional sets of processors, and a memory device storing executable code. The executable code, when executed, causes the processor to receive, from a user device, a request for web-based browser or dedicated application interaction associated with a first entity with which a user holds at least one account, wherein the at least one account comprises a first set of resources. The system receives login credentials and a request for remote user access to the at least one account from a user device over the Internet and authenticates the login credentials. In response to successful authentication of the login credentials, the system generates and transmits a user authentication confirmation over the Internet to the user device and then grants remote user access over the Internet to the user device. The system then receives a request from the user device to link a second entity, with which the user holds a second account, to the first entity, with which the user holds the at least one account, wherein the second account comprises a second set of resources. The system receives a request to deliver a customized resource from the first entity to a third entity and determines whether the first set of resources is sufficient to deliver the requested customized resource to the third entity. In response to determining that the first set of resources is insufficient to deliver the requested customized resource to the third entity, the system determines whether a combination of at least a portion of the first set of resources and at least a portion of the second set of resources is sufficient to deliver the requested customized resource to the third entity. In response to determining that the combination of at least a portion of the first set of resources and at least a portion of the second set of resources is sufficient to deliver the requested customized resource to the third entity, the system transforms the at least a portion of the first set of resources and the at least a portion of the second set of resources into a customized resource. In response to transforming the at least a portion of the first set of resources and the at least a portion of the second set of resources into a customized resource, the system delivers the customized resource to the third entity.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an enterprise system and environment thereof for cross functionality of crypto interactions by transforming resources between centralized and decentralized networks, in accordance with an embodiment of the present invention;

FIG. 2A is a flowchart illustrating a system and method for delivering a customized resource from a first account and a second account associated with a first entity, according to at least one embodiment.

FIG. 2B is a continuation of the flowchart of FIG. 2A.

FIG. 3A is a flowchart illustrating a system for delivering a customized resource from a first entity to a second entity, according to at least one embodiment.

FIG. 3B is a continuation of the flowchart of FIG. 3A.

FIG. 4A is a flowchart illustrating a system for delivering a customized resource from a first and a second entity to a third entity, according to at least one embodiment.

FIG. 4B is a continuation of the flowchart of FIG. 4A.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

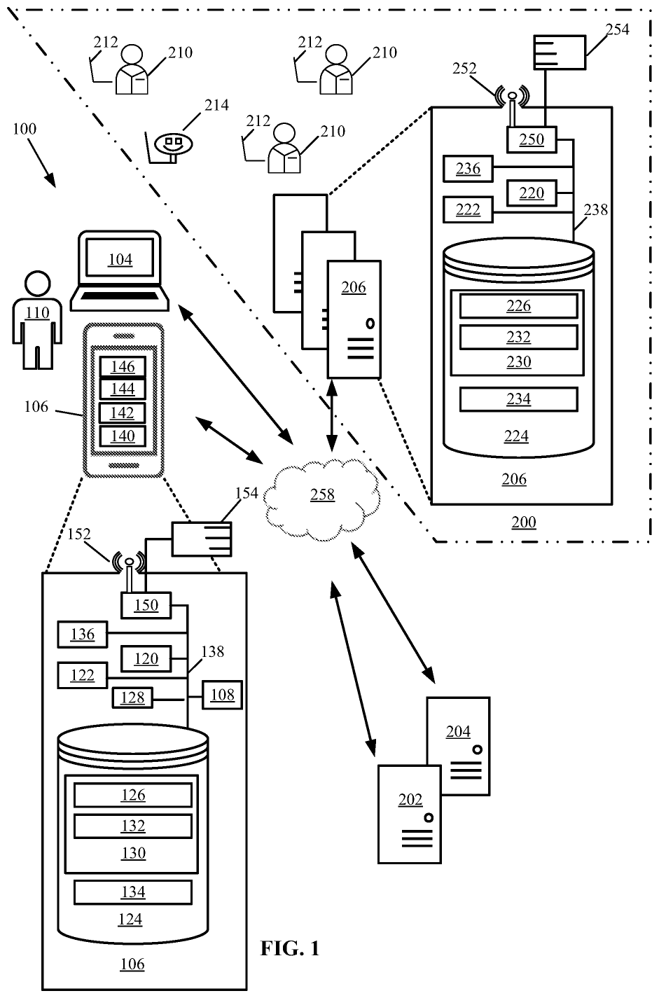

FIG. 1 illustrates a system 100 and environment thereof, according to at least one embodiment, by which a user 110 benefits through use of services and products of an enterprise system 200. The environment may include, for example, a distributed cloud computing environment (private cloud, public cloud, community cloud, and/or hybrid cloud), an on-premise environment, fog computing environment, and/or an edge computing environment. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, IOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a global positioning system device (GPS) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems or banking systems configured to interact with the user device 106 during transactions and also configured to interact with the enterprise system 200 in back-end transactions clearing processes.

In certain embodiments, one or more of the systems such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

In example embodiments, various systems, methods, and computer products provide a user with the ability to initiate a transaction, or interaction, between a first entity and a second entity to deliver a customized resource or payment to the second entity. In example embodiments, the customized resource is a combination of funds from two or more sources or accounts. In some embodiments, the customized resource includes funds from a primary financial institute supplemented or substituted with funds from a secondary financial institute that is a separate entity from the primary financial institute. In particular embodiments, the customized resource or payment solely includes funds or resources from an external funding account, such as from a separate entity.

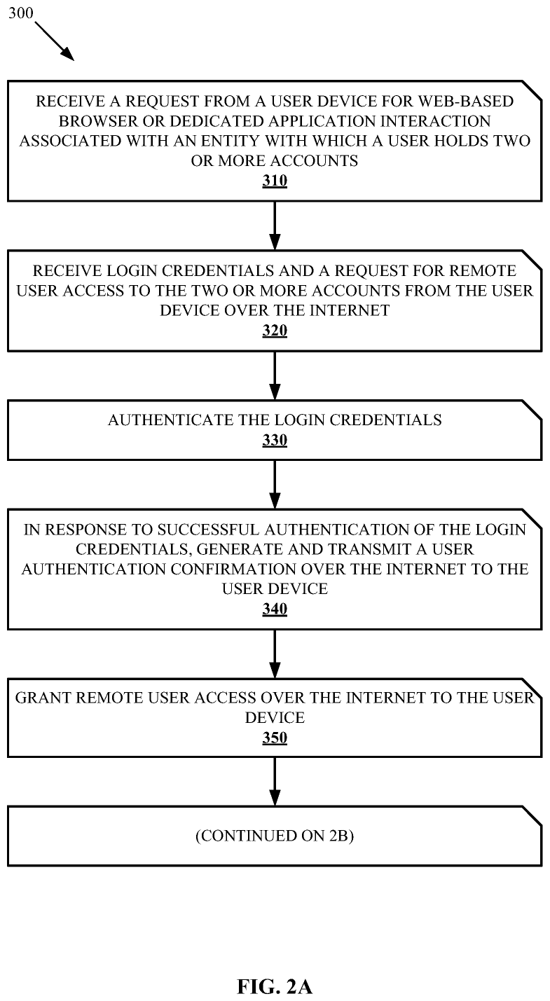

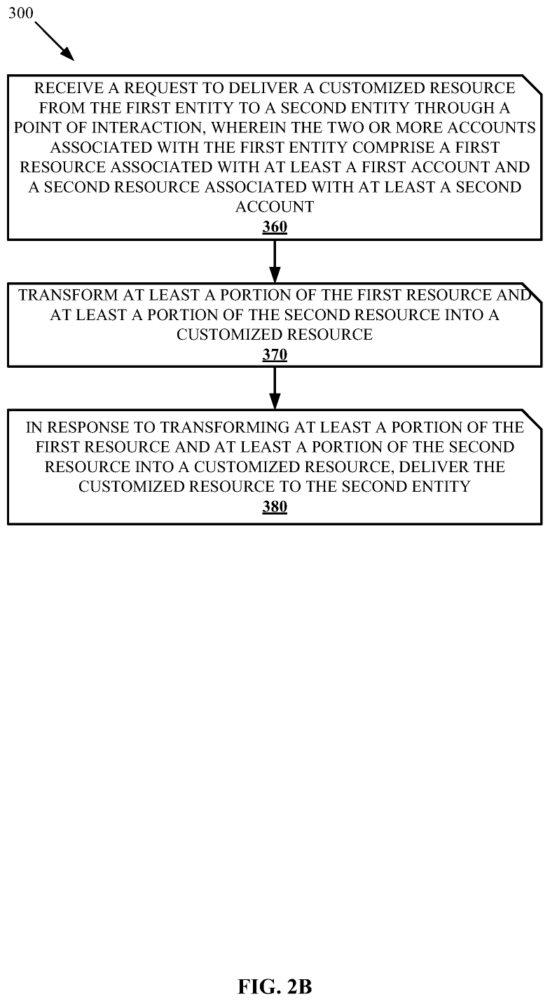

FIGS. 2A-2B is a flow chart representing a system and method 300, according to at least one embodiment, for delivering a customized resource from a first entity to a second entity. In particular embodiments, the system 300 allows a user to complete a single interaction or transaction using two funding sources or resources. In example embodiments, the system includes at least one processor, a communication interface communicatively coupled to the at least one processor and configured to communicate over at least one network with one or more additional sets of processor, and a memory device storing executable code.

The first step, as represented by block 310, is for the executable code to be executed to cause the processor to receive, from a user device, a request for web-based browser or dedicated application interaction associated with a first entity with which a user holds two or more accounts. The web-based browser may be navigated to a website for the entity. The dedicated application may be a mobile application downloaded from an app store or other application hub for mobile devices. In example embodiments, the user account may only be accessed after basic or advanced authentication credentials such as a username, password, or biometric identifiers have been input and authorized by the access control platform.

In example embodiments, the first entity is a financial institute or banking provider. The two or more user accounts that are associated with the first entity may be any suitable account, product, or other relationship. For example, where the first entity is a bank, the two or more user accounts may include any of the following: a checking account, a savings account, a money market account, a certificate of deposit, a mortgage or other loan account, retirement account, brokerage account, or any other suitable account known now or later discovered or developed. In some embodiments, a user may hold two of the same type of account. For example, the user may have a primary checking account and a secondary checking account. In other embodiments, the two or more user accounts may be accessible by only one user, or may include a joint account. For example, a user may have a personal savings account and a joint savings account shared with a spouse.

The next step, as represented by block 320, is to receive login credentials and a request for remote user access to at least one of the two or more accounts from a user device over the Internet. The login credentials correspond to a basic level of remote user access to the user's account(s) and may include a username and password or other basic credentials. The login credentials may be received after a back-end server system initiates a request or from the web-based browser based on directions from the online banking platform (which may come from a back-end server system or another entity system), or may originate from the dedicated mobile app. The login credentials may be received after the user is presented a pop-up window or online with the application or web-site content. The system may also receive the login credentials in response to a user attempting to navigate to information, such as account information, that is confidential and is only disclosed upon basic user authentication. In some embodiments, the login credentials may include a secondary level of authentication, or two-factor authentication, in addition to the basic username and password. For example, the system, upon receipt of the basic login credentials, may send a one-time code to the user's mobile device that must be input from the user device into the web-based browser or dedicated mobile application to gain full access to the user's account(s).

The next step, as represented by block 330, is to authenticate the login credentials. The back-end server system may determine whether the submitted login credentials are sufficient to authenticate the user for remote access. If so, at block 340, the system generates and transmits a user authentication confirmation over the Internet to the user device to grant remote user access over the Internet to the user device, as represented by block 350.

As represented by block 360, the next step is to receive a request to deliver a customized resource from the first entity to a second entity through a point of interaction, wherein the two or more accounts associated with the first entity comprise a first resource associated with at least a first account and a second resource associated with at least a second account.

As previously discussed, the first entity may be a first financial institute and the second entity may be a second and separate financial institute. In some embodiments, the first entity is a first branch of the first financial institute, such as a regular banking branch, and the second entity is a second branch of the first financial institute, such as a mortgage branch. In alternate embodiments, the first and second entity may be any suitable entity for exchanging, trading, buying, or selling resources. For example, as opposed to a traditional banking entity, the first and second entity may include entities that are decentralized computing systems that allow users to have accounts for interactions or transactions using distributed ledger technology (i.e., cryptocurrency networks).

In example embodiments, a point of interaction may include a cash withdrawal, check deposit, online payment, debit or credit card charge, wire transfer, ACH transaction, or loan payment. In some embodiments, the point of interaction may further include a national or international electronic fund transfer, real-time gross settlement, immediate payment service, unified payments interface interactions, bank card interactions, and POS terminal interactions. In various embodiments, the point of interaction is simply bill pay or a transfer of resources or funds from one account to a different account. In example embodiments, the first and second set of resources may be any suitable resource, currency, or fund that may be transferred, exchanged, received, or purchased. For example, the first and second set of resources may each include a total balance amount for each of their respective accounts. In this example, the first account may have a total balance in USD and the second account may have a total balance in Bitcoin. In various embodiments, the first and second set of resources include the same type of resource or currency. In some embodiments, the point of interaction is user-selected. In other embodiments, the point of interaction may be time-based or requested from a third party.

At block 370, the next step is to transform at least a portion of the first resource and at least a portion of the second resource into a customized resource. In example embodiments, the customized resource is a combination of at least a portion of the first resource and at least a portion of the second resource. In particular embodiments, the portions for the combination are allocated by the system based on the total amount or balance of the first resource and the second resource. In other embodiments, the portions for the combination are selected by the user. In various embodiments, the user may select the total amount for the point of interaction, and the system may determine the amount or portion from each account that will be required to complete the point of interaction. In still further embodiments, the user may select only a single account for a point of interaction, but indicate that the second account should be used as a backup in the instance where the first account has insufficient resources to complete the transaction. In example embodiments, the portion of the first and second resource may be equal amounts. In some embodiments, the portion of the first and second resource include a user-selected quantity or percentage, or, conversely, the portion of the first and second resource may include a pre-determined quantity or percentage. For example, the system may determine a total balance of the first resource and the second resource, and at least partially based on determining that the total balance of the first resource is greater than the total balance of the second resource, the system may transform a greater percentage of the first resource than the second resource into the customized resource.

The next step, at block 380, is to deliver the customized resource to the second entity through the point of interaction. For example, where a user has set up a payment with a third-party entity such as a credit card company, the system may receive the request to deliver the customized resource to the third-party entity, determine which funds from each of the user accounts will be sufficient to fulfill the payment request, determine that the full payment amount is greater than any single balance in the user's accounts, and transform or combine a portion from two of the user's accounts into a single, customized resource or payment and deliver the payment to the third-party entity. Similarly, as an example, a user may set up bill pay through a service provided by the first entity. Rather than charging the user with an overdraft fee if the bill-pay was set up to process funds from only the user's checking account but the user's checking account has an insufficient balance to fulfill the bill-pay request, the system may use the available funds from the checking account, and supplement those funds with available funds from the user's savings account. Thus, the system allows a user to combine resources from multiple accounts to avoid overdraft charges or other similar fees in order to simplify and complete a point of interaction or transaction for the user making the entire process seamless for the end user or customer.

In various embodiments, where there is a return or failed point of interaction, for example, where a user returns a purchase for a refund or where a transfer to an external account failed to go through, the system maps how the return or refund will be processed. In example embodiments, the system may return the exact portions pulled from each account to their respective accounts. In other embodiments, the system may map the full return or refund to the user's primary account. In still other example embodiments, the system may notify the user that the point of interaction failed and may subsequently request the user initiate the request again.

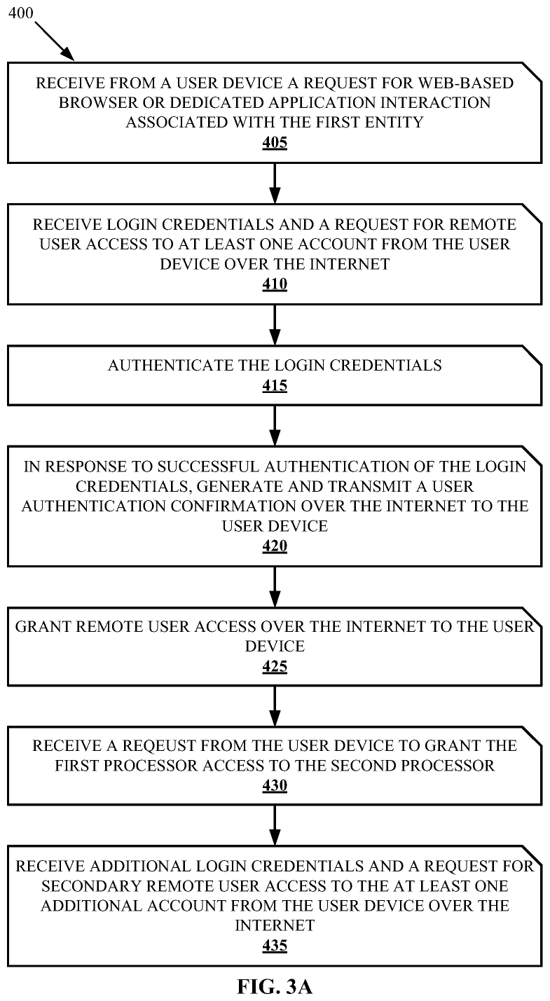

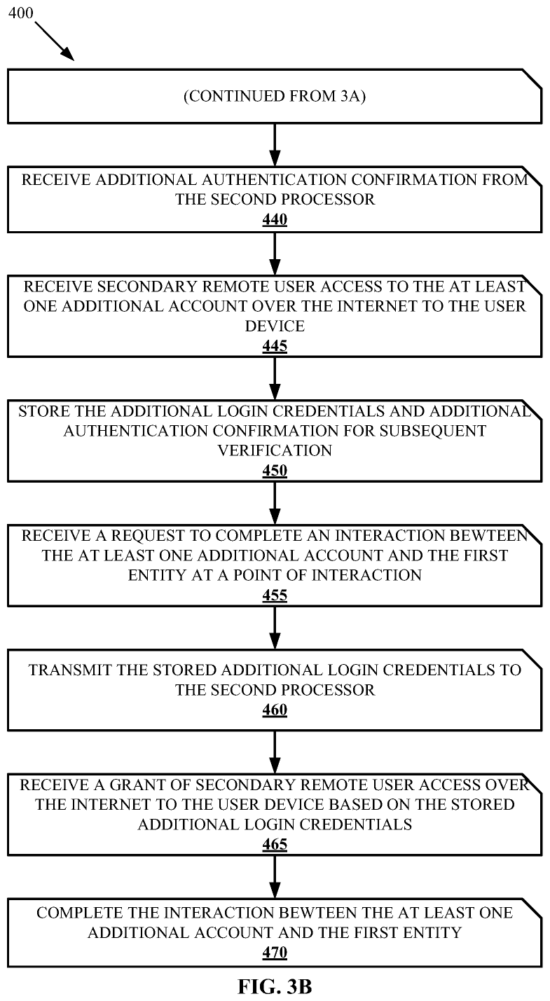

Referring now to FIGS. 3A-3B, a flowchart illustrates a system 400 for delivery of a customized resource according to embodiments of the invention. Although used throughout, the delivery of the customized resource may include any interaction between one or more entities including, but not limited to, a delivery of funds, exchange of funds, a transfer to/from one entity to another or to itself, or a purchase or sale by an entity. In example embodiments, the system 400, allows a user to add an external funding account to an account held by the user that utilizes the enterprise system 200. For example, the account that utilizes the enterprise system 200 may be a bank account or accounts associated with a first financial institute and the external funding account may be a bank account or accounts associated with a second financial institute. In various embodiments, “first account,” “account” and “at least one account” may be used interchangeably to indicate an account the user has at the first financial institute. Similarly, “second account,” “external account,” and “at least one additional account” may be used interchangeably to indicate an account held by the user at a second financial instate that is separate from, or unaffiliated with, the first financial institute. In other embodiments, the second entity may be affiliated with the first financial institute as a subsidiary or any other tangential relationship that requires a user to use different login credentials than the login credentials used for the first entity. In still further embodiments, the second account may be a business, personal, or joint account held by the user and associated with the first entity, but that is separate from the user's first account.

The system and method 400 is performed by a system that includes a first processor associated with a first entity and a second processor associated with a second entity. The first entity may be associated with at least one account, or a first account, held by a user and the second entity may be associated with at least one additional account, or a second account, held by the user. The first account includes a first set of resources and the second account includes a second set of resources. The system further includes a communication interface communicatively coupled to the first processor and configured to communicate over at least one network with at least the second processor. A memory device, storing executable code, causes the first processor to perform the following steps.

Many features of the system that performs method 400 are the same or similar to those features recited above with regard to FIG. 2. Thus, for purposes of ease of understanding and clarity, only certain features will be discussed to highlight the differences in the systems and methods of the embodiment shown in FIG. 2 as compared to the embodiment shown in FIG. 3.

The first step, as represented by block 405, similar to the system and method described with reference to FIG. 2, is to receive from a user device a request for web-based browser or dedication application interaction associated with the first entity. At block 410, the system receives login credentials and a request for remote user access to the at least one account from the user device over the Internet and authenticates the login credentials at block 415. In response to successful authentication, at block 420, the system generates and transmits a user authentication confirmation over the Internet to the user device and grants remote user access to the user device at block 425.

The next step, as represented by block 430, is to receive a request from the user device to grant the first processor access to the second processor. In various embodiments, the request is received from the user device while the user is interacting with the web-based browser or dedicated application associated with the first entity. For example, when the user is accessing the bill-pay feature of the first entity, the user may select an option to add an external account. In this case, the external account is the second account (the at least one additional account) associated with the second entity.

At block 435, the next step is to receive additional authentication confirmation from the second processor. At block 440, the system receives additional authentication confirmation from the second processor, and at block 445, the system receives secondary remote user access to the at least one additional account over the Internet to the user device. Similar to the first entity, the second entity likely requires at least basic login credentials to access the user's account(s) associated with the second entity. In some embodiments, the second entity may require multi-factor authentication, as well.

Next, at block 450, is storing the additional login credentials and additional authentication confirmation for subsequent verification. For example, the system may store the login credentials and additional authentication confirmation for the next time the user attempts to access the external or additional account associated with the second entity. The login credentials and authentication confirmation may also be stored and communicated directly or indirectly to the back-end network if the user has selected the additional account as a backup payment source, as discussed above. Further, the system may update the communication interface to include the at least one additional account to any drop-down menu or selection options for any service or product offered by the first entity. This allows the user to have a seamless experience with the system when completing interactions or transactions. For example, when attempting to send a payment to cover a credit card balance, the user may select the bill-pay webpage, select the payee, select the funding source—in this case the at least one additional account associated with the second entity—and then submit the payment. In various embodiments, similar to accounts held by the user at the first entity, the system may also display balance information for the additional account when that account is accessed or viewed in a drop-down or other type of selectable option.

Then, at block 455, the system receives a request to complete an interaction between the at least one additional account and the first entity at a point of interaction. In example embodiments, the interaction between the at least one additional account and the first entity occurs at the point of interaction. Or, simply put, the point of interaction is the selected interaction, exchange, or transaction between the two accounts of the two entities selected from, but not limited to, any of the following: a cash withdrawal, check deposit, online payment, debit or credit card charge, wire transfer, ACH transfer or transaction, and a loan payment or other online bill-pay. Thus, the point of interaction, in example embodiments, similar to above may be any product or service offered by the first entity and accessible by the user, where the user selects or has selected the at least one additional account as a payment sending or receiving source or account.

Continuing to block 460, the next step is to transmit the stored additional login credentials to the second processor, and, at block 465, receive a grant of secondary remote user access over the Internet to the user device based on the stored additional login. Then, at block 470, the system completes the interaction between the at least one additional account and the first entity. The interaction may be completed by transferring resources from the additional account, to the account associated with the first entity, then transferring the resources as instructed by the user by the selection of the point of interaction received when the system receives the request to complete the interaction.

In various embodiments, the system may further receive a request to deliver a customized resource to a third party. In example embodiments, the system may transform at least a portion of the first set of resources associated with the at least one account and at least a portion of the second set of resources associated with the at least one additional account in order to create and deliver the customized resource to a third entity or party. In some embodiments, in order to fulfill the request to deliver the customized resource to the third entity, the system may determine whether the first set of resources is sufficient to deliver the requested customized resource to the third party, and, in response to determining that the first set of resources is insufficient to deliver the requested customized resource, the system may determine whether a combination of at least a portion of the first set of resources and at least a portion of the second set of resources is sufficient to deliver the requested customized resource. If the combination is sufficient, the next step is to transform the at least a portion of the first set of resources and the at least a portion of the second set of resources into a customized resource and deliver the customized resource to the third party. For example, where a primary checking account at the first entity has a balance of $100, a savings account at the second entity has a balance of $1000, and the user is attempting to transfer $200 to a friend through Zelle®, Venmo®, PayPal® or any other suitable system for processing electronic payments and for transferring funds to and from others, the system may combine $50 from the primary checking account and $150 from the savings account in order to process the transfer to the user's friend.

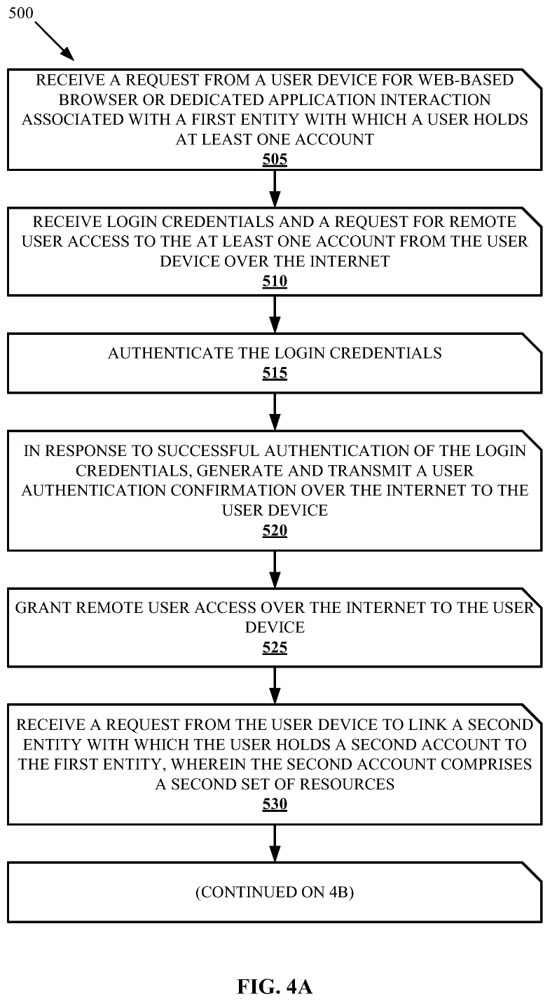

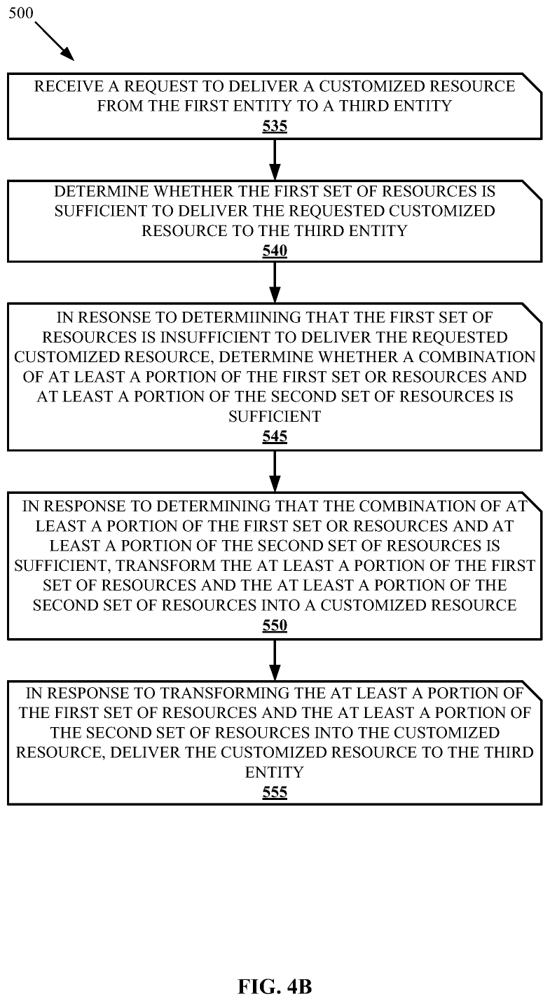

Referring now to FIG. 4, a flowchart illustrates a system 500 for delivery of a customized resource according to embodiments of the invention. In example embodiments, the system 500 allows a user to add an external account for use as a backup funding source. Many features of the system that performs method 500 are the same or similar to those features recited above with regard to FIG. 3. Thus, for purposes of ease of understanding and clarity, only certain features will be discussed to highlight the differences in the systems and methods of the embodiment shown in FIG. 3 as compared to the embodiment shown in FIG. 4.

In example embodiments, the system 500 includes at least one processor, a communication interface communicatively coupled to the at least one processor and configured to communicate over at least one network with one or more additional sets of processors, and a memory device storing executable code.

The first step, as represented by block 505, is to receive from a user device a request for web-based browser or dedicated application interaction associated with a first entity with which a user holds at least one account, wherein the at least one account includes a first set of resources. As discussed above, the set of resources may be any suitable funds or currency that may be exchanged, transferred, received, or purchased.

The next step, as represented by block 510, is to receive login credentials and a request for remote user access to the at least one account from a user device over the Internet. At step 515, the next step is to authenticate the login credentials, and, in response to successful authentication of the login credentials, generate and transmit a user authentication confirmation over the Internet to the user device at step 520. At block 525, the next step is to grant the user device remote user access.

The next step, as represented by block 530, is to receive a request from the user device to link a second entity with which the user holds a second account to the first entity, wherein the second account includes a second set of resources. In various embodiments, the second set of resources may be the same or different type of resource than the first set of resources. In linking the second entity to the first entity, the user device or the back-end server system may initiate the authentication of the user for remote access to one or more systems associated with the second entity.

The next step, as represented by block 535, is to receive a request to deliver a customized resource from the first entity to a third entity. In example embodiments, the third entity is unrelated, separate, and unaffiliated with either the first entity or the second entity. In other embodiments, the third entity is tangentially related to the first entity or the second entity, but still requires the user to utilize different login credentials and requires a separate authentication process.

After receiving the request, the next step at block 540 is to determine whether the first set of resources is sufficient to deliver the request customized resource to the third entity. In response to determining that the first set of resources is insufficient to deliver the requested customized resource to the third entity, the next step at block 545 is to determine whether a combination of at least a portion of the first set of resources and at least a portion of the second set of resources is sufficient to deliver the requested customized resource to the third entity. In response to determining that the combination of the two portions is sufficient, the next step at block 550 is to transform the portions of the first and second set of resources into a customized resource. In response to transforming the combination of the portions of the resources, at block 555, the system delivers the customized resource to the third entity. As discussed, the customized resource may be any combination of resources or a single resource that is sufficient to fulfill the requested delivery of the customized resource.

What is claimed is:

1. A system for delivery of a customized resource, the system comprising:
at least one processor;
a communication interface communicatively coupled to the at least one processor and configured to communicate over at least one network with one or more additional sets of processors; and
a memory device storing executable code that, when executed, causes the processor to:
receive, from a user device, a request for web-based browser or dedicated application interaction associated with a first entity with which a user holds two or more accounts;
receive login credentials and a request for remote user access to at least one of the two or more accounts from a user device over the Internet;
authenticate the login credentials;
in response to successful authentication of the login credentials, generate and transmit a user authentication confirmation over the Internet to the user device;
grant remote user access over the Internet to the user device;
receive a request to deliver a customized resource from the first entity to a second entity through a point of interaction, wherein the two or more accounts associated with the first entity comprise a first resource associated with at least a first account and a second resource associated with at least a second account;
transform at least a portion of the first resource and at least a portion of the second resource into a customized resource; and
in response to transforming at least a portion of the first resource and at least a portion of the second resource into a customized resource, deliver the customized resource to the second entity.

2. The system of claim 1, wherein the point of interaction comprises at least one of a cash withdrawal, check deposit, online payment, debit or credit card charge, wire transfer, ACH transaction, and loan payment.

3. The system of claim 1, wherein the point of interaction comprises at least one of a national electronic fund transfer, real time gross settlement, immediate payment service, unified payments interface interaction, bank card interaction, and POS terminal interaction.

4. The system of claim 1, wherein the point of interaction comprises an electronic fund transfer.

5. The system of claim 1, wherein the executable code, when executed, further causes the processor to:
determine a total balance of the first resource;
determine a total balance of the second resource; and
at least partially based on determining that the total balance of the first resource is greater than the total balance of the second resource, transform a greater percentage of the first resource than the second resource into the customized resource.

6. The system of claim 1, wherein the executable code, when executed, further causes the processor to:
determine a total balance of the first resource;
determine a total balance of the second resource; and
at least partially based on determining that the total balance of the first resource is greater than the total balance of the second resource, transform an equal amount of the first resource and the second resource into the customized resource.

7. The system of claim 1, wherein:
the at least a portion of the first resource comprises a first selection of a quantity of the first resource received from the user device; and
the at least a portion of the second resource comprises a second selection of a quantity of the second resource received from the user device.

8. The system of claim 1, wherein when the first resource and the second resource comprise a currency.

9. A method for delivery of a customized resource, the method comprising:
receiving, from a user device, a request for web-based browser or dedicated application interaction associated with a first entity with which a user holds two or more accounts;
receiving login credentials and a request for remote user access to at least one of the two or more accounts from a user device over the Internet;
authenticating the login credentials;
in response to successfully authenticating the login credentials, generating and transmitting a user authentication confirmation over the Internet to the user device;
granting remote user access over the Internet to the user device;
receiving a request to complete an interaction between the first entity and a second entity, wherein the two or more accounts associated with the first entity comprise a first resource associated with at least a first account and a second resource associated with at least a second account;
transforming the first resource and the second resource into a customized resource, wherein the customized resource comprises at least a portion of the first resource and at least a portion of the second resource; and
in response to transforming the first resource and the second resource into a customized resource, completing the interaction between the first entity and the second entity.

10. The method of claim 9, wherein:
the at least a portion of the first resource and the at least a portion of the second resource each comprise at least one of a user-selected quantity, a user-selected percentage, a pre-determined quantity, and a pre-determined percentage.

11. A system for delivery of a customized resource, the system comprising:
a first processor associated with a first entity and a second processor associated with a second entity, wherein a user holds at least one account associated with the first entity, wherein the user holds at least one additional account associated with the second entity, and wherein a first set of resources is associated with the at least one account and a second set of resources is associated with the at least one additional account;
a communication interface communicatively coupled to the first processor and configured to communicate over at least one network with at least the second processor; and
a memory device storing executable code that, when executed, causes the first processor to:
receive, from a user device, a request for web-based browser or dedicated application interaction associated with the first entity;
receive login credentials and a request for remote user access to the at least one account from the user device over the Internet;
authenticate the login credentials;
in response to successful authentication of the login credentials, generate and transmit a user authentication confirmation over the Internet to the user device;
grant remote user access over the Internet to the user device;
receive a request from the user device to grant the first processor access to the second processor;
receive additional login credentials and a request for secondary remote user access to the at least one additional account from the user device over the Internet;
receive additional authentication confirmation from the second processor;
receive secondary remote user access to the at least one additional account over the Internet to the user device;
store the additional login credentials and additional authentication confirmation for subsequent verification;
receive a request to complete an interaction between the at least one additional account and the first entity at a point of interaction;
transmit the stored additional login credentials to the second processor;
receive a grant of secondary remote user access over the Internet to the user device based on the stored additional login credentials; and
complete the interaction between the at least one additional account and the first entity.

12. The system of claim 11, wherein the interaction between the at least one additional account and the first entity comprises at least one of a cash withdrawal, check deposit, online payment, debit or credit card charge, wire transfer, ACH transaction, and loan payment.

13. The system of claim 11, wherein the executable code, when executed, further causes the first processor to:
receive a request to deliver a customized resource to a third entity;
transform at least a portion of the first set of resources and at least a portion of the second set of resource into a customized resource; and
in response to transforming at least a portion of the first set of resources and at least a portion of the second set of resource into a customized resource, deliver the customized resource to the third entity.

14. The system of claim 11, wherein the executable code, when executed, further causes the first processor to:
receive a request to deliver a customized resource from the first entity to a third entity;
determine whether the first set of resources is sufficient to deliver the requested customized resource to the third entity;
in response to determining that the first set of resources is insufficient to deliver the requested customized resource to the third entity, determine whether a combination of at least a portion of the first set of resources and at least a portion of the second set of resources is sufficient to deliver the requested customized resource to the third entity;
in response to determining that the combination of at least a portion of the first set of resources and at least a portion of the second set of resources is sufficient to deliver the requested customized resource to the third entity, transform the at least a portion of the first set of resources and the at least a portion of the second set of resources into a customized resource; and
in response to transforming the at least a portion of the first set of resources and the at least a portion of the second set of resources into a customized resource, deliver the customized resource to the third entity.

15. The system of claim 11, wherein the first entity is a first financial institution and the second entity is a second financial institution.

16. A system for delivery of a customized resource, the system comprising:
at least one processor;
a communication interface communicatively coupled to the at least one processor and configured to communicate over at least one network with one or more additional sets of processors; and
a memory device storing executable code that, when executed, causes the processor to:
receive, from a user device, a request for web-based browser or dedicated application interaction associated with a first entity with which a user holds at least one account, wherein the at least one account comprises a first set of resources;
receive login credentials and a request for remote user access to the at least one account from a user device over the Internet;
authenticate the login credentials;
in response to successful authentication of the login credentials, generate and transmit a user authentication confirmation over the Internet to the user device;
grant remote user access over the Internet to the user device;
receive a request from the user device to link a second entity with which the user holds a second account to the first entity with which the user holds the at least one account, wherein the second account comprises a second set of resources;
receive a request to deliver a customized resource from the first entity to a third entity;
determine whether the first set of resources is sufficient to deliver the requested customized resource to the third entity;
in response to determining that the first set of resources is insufficient to deliver the requested customized resource to the third entity, determine whether a combination of at least a portion of the first set of resources and at least a portion of the second set of resources is sufficient to deliver the requested customized resource to the third entity;
in response to determining that the combination of at least a portion of the first set of resources and at least a portion of the second set of resources is sufficient to deliver the requested customized resource to the third entity, transform the at least a portion of the first set of resources and the at least a portion of the second set of resources into a customized resource; and
in response to transforming the at least a portion of the first set of resources and the at least a portion of the second set of resources into the customized resource, deliver the customized resource to the third entity.

17. The system of claim 16, wherein the request to deliver the customized resource comprises at least one of bill pay, ACH transaction, and electronic transfer.

18. The system of claim 16, wherein the first entity is a first financial institution and the second entity is a second financial institution.

19. The system of claim 16, wherein the at least a portion of the first resource and the at least a portion of the second resource each comprise at least one of a user-selected quantity, a user-selected percentage, a pre-determined quantity, and a pre-determined percentage.

20. The system of claim 16, wherein the delivery of the customized resource to the third entity comprises an electronic fund transfer.
